(19) United States
(12) Patent Application Publication
(10) Pub. No.: US 2024/0211546 A1
(43) Pub. Date: Jun. 27, 2024

(54) GROUNDWATER POLLUTION SOURCE IDENTIFICATION METHOD AND APPARATUS, COMPUTER DEVICE, AND STORAGE MEDIUM

(71) Applicant: CHINESE RESEARCH ACADEMY OF ENVIRONMENTAL SCIENCES, Beijing (CN)

(72) Inventors: Yonghai Jiang, Beijing (CN); Xinying Lian, Beijing (CN); Fu Xia, Beijing (CN); Yu Yang, Beijing (CN); Zhichao Yun, Beijing (CN); Qiyuan Liu, Beijing (CN); Yongge Zang, Beijing (CN)

(21) Appl. No.: 18/396,325

(22) Filed: Dec. 26, 2023

(30) Foreign Application Priority Data
Dec. 27, 2022 (CN) 202211682838.4

(51) Int. Cl. G06F 18/2413; G06N 3/08

(52) U.S. Cl. CPC G06F 18/2413; G06N 3/08

(57) ABSTRACT

A groundwater pollution source identification method, comprising: acquiring sample data for groundwater pollution source detection, the sample data at least comprising water chemical index concentration data, pollutant concentration data, longitude and latitude coordinates, surface water system data, and enterprise type data; calculating the Euclidean distance and the clustering distance between the sample data and the corresponding output neuron weight vector; performing weighted calculation on the Euclidean distance and the clustering distance to determine the winning neuron; updating the output neuron weight vector of the water pollution neural network according to the input neuron weight vector and the output neuron weight vector of the winning neuron; and when the number of updating times of the output neuron weight vector of the water pollution neural network reaches a preset value, determining the groundwater pollution source of the target area by the updated water pollution neural network.

### BACKGROUND

### Technical Field

The present application relates to the technical field of water environments, and in particular, to a groundwater pollution source identification method and apparatus, computer device, and storage medium.

### Description of the Related Art

Along with the rapid development of economic society in China, many groundwater pollution sites also appear, so that the identification of the groundwater pollution sources is urgent in groundwater environment pollution research. For the problems of various types of groundwater pollution sources, complex approaches and difficult accurate identification, many groundwater pollution traceability research methods, such as model algorithm, chemical tracing method, statistical method, etc., have been generated.

As various indexes of groundwater are various, the amount of samples is very large, and the data can be processed by using methods such as dimensionality reduction and clustering. Principal component analysis (PCA), factor analysis (FA), etc., are all common methods, but they belong to linear methods, and when processing environmental data, the nonlinear relationship between interpretation variables often has limitations, thus leading to lower accuracy of groundwater pollution source identification.

### BRIEF SUMMARY

An embodiment of the present disclosure provides a method for identifying groundwater pollution source, including:
acquiring sample data for groundwater pollution source detection, the sample data at least comprising water chemical index concentration data, pollutant concentration data, longitude and latitude coordinates, surface water system data, and enterprise type data;
calculating the Euclidean distance and the clustering distance between the sample data and the corresponding output neuron weight vector;
performing weighted calculation on the Euclidean distance and the clustering distance to determine the winning neuron;
updating the output neuron weight vector of the water pollution neural network according to the input neuron weight vector and the output neuron weight vector of the winning neuron;
when the number of updating times of the output neuron weight vector of the water pollution neural network reaches a preset value, determining the groundwater pollution source of the target area by the updated water pollution neural network.

### DESCRIPTION OF DRAWINGS

FIG. 1 is flowchart of an groundwater pollution source identification method provided by the present application;

FIG. 2 is mapping feature map of multi-dimensional data indexes in groundwater provided by the present application;

FIG. 3 is clustering result of different point positions in SOM according to the present application;

FIG. 4 is schematic structural diagram of groundwater pollution source identification apparatus provided by the present application;

FIG. 5 is schematic diagram of computer device according to the present application.

### DETAILED DESCRIPTION

In order to better understand the above-mentioned technical solutions, the technical solutions of the embodiments of the present application are described in detail below with reference to the accompanying drawings and specific embodiments, and it should be understood that the specific features in the embodiments and embodiments of the present application are detailed description of the technical solutions of the embodiments of the present application, and are not limited to the technical solutions of the present application, and in the case of no conflict, the technical features in the embodiments and embodiments of the present application may be combined with each other.

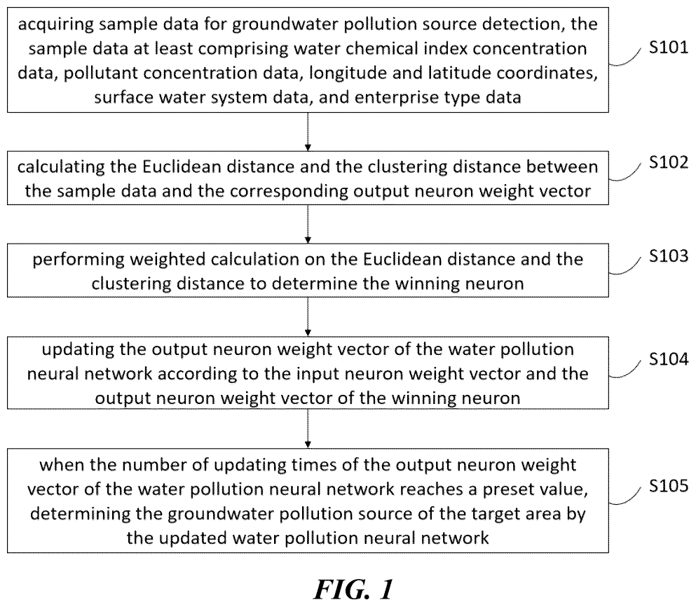

Please refer to FIG. 1, which is an groundwater pollution source identification method according to an embodiment of the present disclosure, which is used to perform steps S101 to S105:

S101, acquiring sample data for groundwater pollution source detection, the sample data at least comprising water chemical index concentration data, pollutant concentration data, longitude and latitude coordinates, surface water system data, and enterprise type data.

The sample data detected in the groundwater pollution source detection is preprocessed, the information of the data class is summarized according to the characteristics, the pollutant concentration, the longitude and latitude coordinates and the like are directly represented by the original data, and the data is standardized by using the data_struct and the normalize instructions provided by the somtoolbox in the MATLAB. Data such as pollution source conditions, surface water system conditions and the like are reasonably numbered or datamated through actual conditions, the surface water system uses binary coding to describe the existence condition, and it can be set to 1 to indicate that there is existence, 0 indicates that there is no existence, and the subsequent binary coding condition is the same. The flow direction is set according to the plane coordinate vector, and data is set according to the flow direction angle by taking the position where the point position is located as an origin. The pollution source uses binary codes according to types such as industrial pollution source, mine mining area, refuse landfill, gas station, agricultural pollution source, and surface sewage.

The monitoring indexes include pH, total hardness (in CaCO3), sulfate, chloride, permanganate index, nitrate, nitrite nitrogen, ammonia nitrogen, fluoride, cyanide, manganese, cadmium, lead, iron, hexavalent chromium, zinc, and soluble total solids, Table 1 is field monitoring index data statistical characteristics, i.e., water chemical index concentration data.

TABLE 1

| | Mean | Highest value |
|---|---|---|
| pH | 7.42 | 8.39 |
| Total hardness (in | 365.11 | 557.00 |
| CaCO3) | | |
| Sulfate | 96.79 | 248.00 |
| Chloride | 64.34 | 194.00 |
| Permanganate | 0.65 | 1.70 |
| index | | |
| Nitrate | 15.22 | 45.40 |
| Nitrite nitrogen | 0.02 | 0.05 |
| Ammonia nitrogen | 0.04 | 0.70 |
| Fluoride | 0.60 | 1.73 |
| Cyanide | 0.01 | 0.09 |
| Manganese | 0.02 | 0.04 |
| Cadmium | 0.01 | 0.01 |
| Lead | 0.01 | 0.02 |
| Iron | 0.03 | 0.04 |
| Hexavalent | 0.01 | 0.05 |
| chromium | | |
| Zinc | 0.03 | 0.17 |
| Soluble total solids | 818.91 | 996.00 |

According to the collected data, the monitoring index and the longitude and latitude data of the monitoring point position are using original data directly, and the data of the surface water system condition, the enterprise type and the like in the research area are using binary coding to illustrate the existence condition. The industrial pollution source, the mine mining area, the garbage landfill, the gas station, the agricultural pollution source and the surface water system are distinguished according to “1 is present, and 0 is not present” (Table 2), in other words, the data in Table 2 is a data label corresponding to the sample data, that is, water pollution source corresponding to the sample data, the water pollution source may specifically be industrial pollution source, mine mining area, garbage landfill, gas station, agricultural pollution source, etc., which is not specifically limited in this embodiment.

TABLE 2

| | Industrial | Mine | | Agricultural | Surface |
|---|---|---|---|---|---|
| | pollution | mining | Gas | pollution | water |
| NO. | source | area | station | source | system |
| 1 | 1 | 0 | 0 | 0 | 1 |
| 2 | 1 | 0 | 1 | 0 | 0 |
| 3 | 1 | 0 | 0 | 0 | 0 |
| 4 | 0 | 0 | 0 | 0 | 0 |
| 5 | 1 | 0 | 0 | 0 | 0 |
| 6 | 0 | 0 | 0 | 0 | 0 |
| 7 | 1 | 0 | 0 | 0 | 0 |
| 8 | 0 | 0 | 0 | 0 | 0 |
| 9 | 1 | 0 | 0 | 0 | 0 |
| 10 | 0 | 0 | 0 | 0 | 0 |
| 11 | 0 | 0 | 0 | 0 | 0 |
| 12 | 0 | 0 | 0 | 0 | 0 |
| 13 | 0 | 0 | 0 | 0 | 0 |
| 14 | 0 | 0 | 0 | 0 | 0 |
| 15 | 1 | 0 | 0 | 0 | 0 |
| 16 | 1 | 1 | 1 | 0 | 1 |
| 17 | 1 | 0 | 1 | 0 | 0 |
| 18 | 1 | 0 | 1 | 0 | 0 |
| 19 | 1 | 1 | 1 | 0 | 0 |
| 20 | 1 | 0 | 1 | 0 | 0 |
| 21 | 1 | 0 | 1 | 1 | 1 |
| 22 | 1 | 1 | 1 | 1 | 1 |
| 23 | 1 | 1 | 1 | 1 | 1 |
| 24 | 1 | 0 | 1 | 0 | 0 |
| 25 | 0 | 0 | 0 | 0 | 0 |
| 26 | 0 | 0 | 0 | 0 | 0 |
| 27 | 0 | 0 | 0 | 0 | 0 |
| 28 | 0 | 0 | 0 | 0 | 0 |
| 29 | 0 | 1 | 0 | 0 | 0 |
| 30 | 0 | 0 | 0 | 0 | 0 |

Step S102, calculating the Euclidean distance and the clustering distance between the sample data and the corresponding output neuron weight vector.

In this embodiment, according to the principle of self-organizing mapping (SOM), it is assumed that the sample data is n dimension, and the weight vector of the calculation layer between the input unit i and the neuron j is W={Wi,j, j=1, . . . N}, where N is the number of sample data. Further, the SOM output size, i.e., the SOM mesh size, is constructed. The size of the two-dimensional SOM grid is determined by m*n, and in order to obtain an appropriate mn value, quantization error (QE) and topology graph error (TE) need to be considered, this process needs to calculate the values of QE and TE under each SOM size by means of cyclic calculation, and by setting different grid sizes, the performance of topological structures of different grid sizes of SOM is evaluated by using QE and TE. Different sizes may also be set according to specific requirements, and are usually set to 5\sqrt{N}. After saving the results of QE and TE, the drawing instruction is written to obtain the SOM output model. The self-organizing learning process of the self-organizing mapping neural network may be summarized as the following several sub-processes.
(1) Initializing SOM neural network. The weight vector is used to assign values to the initial neuron of the output layer.
(2) Inputting the processed groundwater-related data table into the input layer. The index data item, the index name item, and the total term are sequentially set through the data function, and the sum of squares of the difference between the connection weight and the corresponding input value is calculated by scanning the weight vector corresponding to the index data item and the neuron of the output layer. For each data of the index data item, an closest output layer neuron by Euclidean distance is found, which is determined as the winning neuron. The winning neuron obtained by competition is the result corresponding to the dimension reduction of the groundwater related data obtained in the primary training of the SOM, and this result is visually displayed in the output layer neuron. The following is calculation formula of the competition process.

In an optional embodiment of the present disclosure, calculating the Euclidean distance between the sample data and the corresponding output neuron weight vector, including:
calculating the Euclidean distance between the sample data and the output neuron by the following formula:

$$\\ d ( {x}_{j} ) = \sqrt{{\sum }_{i = 1}^{n} {( {w}_{ji} - {x}_{ji} )}^{2}}$$

where d(xⱼ) is the Euclidean distance between the jth sample data and the output neuron, j∈[1, N], N is the number of the sample data, wⱼᵢ is the output neuron weight vector, xⱼᵢ is the input neuron weight vector corresponding to the ith data dimension in the jth sample data, n is the data dimension of the sample data.

In an optional embodiment of the present disclosure, calculating the clustering distance between the sample data and the corresponding output neuron weight vector, including:
calculating the clustering distance between the sample data and the output neuron by the following formula:

$$\\ dist ( {x}_{j} , {w}_{j} ) = ‖ {x}_{j} - {w}_{j} ‖$$

where dist(xⱼ, wⱼ) is the clustering distance between the sample data and the output neuron, j∈[1, N], N is the number of the sample data, xⱼ is the jth sample data, and wⱼᵢ is the jth output neuron.

In this embodiment, the clustering distance between the sample data and the output neuron is calculated based on the CURE algorithm, and then the convergence efficiency of the SOM result is optimized. Each point in the initial time of the CURE algorithm is a cluster, samples are randomly selected from the initial clustering data, the clustering distance between the sample data and the output neurons is calculated, and isolated points can be removed through random sampling. The convergence coefficient α (which may be set to 0.2) is defined, causing the sample point to move a fixed proportion to the centroid O. Further, clustering is performed on locally generated clusters, and iterative computation is performed. Finally, the result clustering label is labeled, and the clustering result is close to the overall form of the groundwater multi-dimensional data in the space structure.

Step S103, performing weighted calculation on the Euclidean distance and the clustering distance to determine the winning neuron.

In an optional embodiment of the present disclosure, the said performing weighted calculation on the Euclidean distance and the clustering distance to determine the winning neuron, including: obtaining a minimum Euclidean distance and a minimum clustering distance; and performing weighted calculation on the minimum Euclidean distance and the minimum clustering distance to determine a winning neuron.

Step S104, updating the output neuron weight vector of the water pollution neural network according to the input neuron weight vector and the output neuron weight vector of the winning neuron.

In an optional embodiment of the present disclosure, the said updating the output neuron weight vector of the water pollution neural network according to the input neuron weight vector and the output neuron weight vector of the winning neuron, including: obtaining the influence range of the winning neuron; updating the output neuron weight vector of the water pollution neural network according to the influence range, the input neuron weight vector and the output neuron weight vector of the winning neuron.

The influence range of the winning neuron is calculated by using the following formula:

$$\\ σ ( t ) = {σ}_{0} {e}^{{}_{} - \frac{t}{{τ}_{0}}}$$

where σ(t) is the influence range of the winning neuron, σ₀ is the initial influence range of the winning neuron, t is the time length, τ₀ is the fixed attenuation coefficient.
updating the output neuron weight vector of the water pollution neural network by using the following formula:

$$\\ Δ {w}_{p} = η ( t ) * T ( t ) * ( {x}_{p} - {w}_{p} )$$

$$\\ η ( t ) = {η}_{0} {e}^{{}_{} - \frac{t}{{τ}_{n}}}$$

$$\\ T ( t ) = {e}^{{}_{} - \frac{{d}_{{pq}_{}}^{{}_{} 2}}{2 {σ ( t )}^{2}}}$$

where Δwₚ is the updated output neuron weight vector of the water pollution neural network, η(t) is the learning coefficient that is attenuated over time, T(t) is the neighborhood influence coefficient, η₀ is the initial value of the learning coefficient, xₚ is the input neuron weight vector of the winning neuron, wₚ is the output neuron weight vector of the winning neuron, d_{pq} is the Euclidean distance between the winning neuron and its neighbor neuron, τ_{η} is the fixed learning coefficient, σ(t) is the influence range of the winning neuron.

Step S105, when the number of updating times of the output neuron weight vector of the water pollution neural network reaches a preset value, determining the groundwater pollution source of the target area by the updated water pollution neural network.

The above calculation is repeated, and the trained water pollution neural network is obtained through multiple iterations, and then the groundwater pollution source of the target area is determined based on the trained water pollution neural network. Specifically, the water chemical index concentration data, the pollutant concentration data, the longitude and latitude coordinates, the surface water system data and the enterprise type data of the target area are input neuron weight vector, and are input into the trained water pollution neural network to obtain the groundwater pollution source corresponding to the target area, and the specific type of the groundwater pollution source is the pollution type in Table 2.

In this embodiment, the construction of water pollution neural network (SOM-CURE model) is performed according to multi-dimensional data, factors that may affect the source-sink relationship in the research area are fully considered, the distribution relationship and law in the space between the point positions are explored, the possible situations that may affect the groundwater pollution are comprehensively analyzed, and certain theoretical support and actual value are provided for groundwater pollution source sink relationship diagnosis and pollution prevention and control governance work.

The disclosure provides a groundwater pollution source identification method, first acquiring sample data for groundwater pollution source detection, the sample data at least comprising water chemical index concentration data, pollutant concentration data, longitude and latitude coordinates, surface water system data, and enterprise type data; then calculating the Euclidean distance and the clustering distance between the sample data and the corresponding output neuron weight vector; performing weighted calculation on the Euclidean distance and the clustering distance to determine the winning neuron; updating the output neuron weight vector of the water pollution neural network according to the input neuron weight vector and the output neuron weight vector of the winning neuron; and when the number of updating times of the output neuron weight vector of the water pollution neural network reaches a preset value, determining the groundwater pollution source of the target area by the updated water pollution neural network. Due to the fact that the output neuron weight vector of the water pollution neural network is jointly updated according to the Euclidean distance and the clustering distance in the present disclosure, the water pollution neural network is trained more accurately, and then the accuracy of the groundwater pollution source determined through the water pollution neural network is improved.

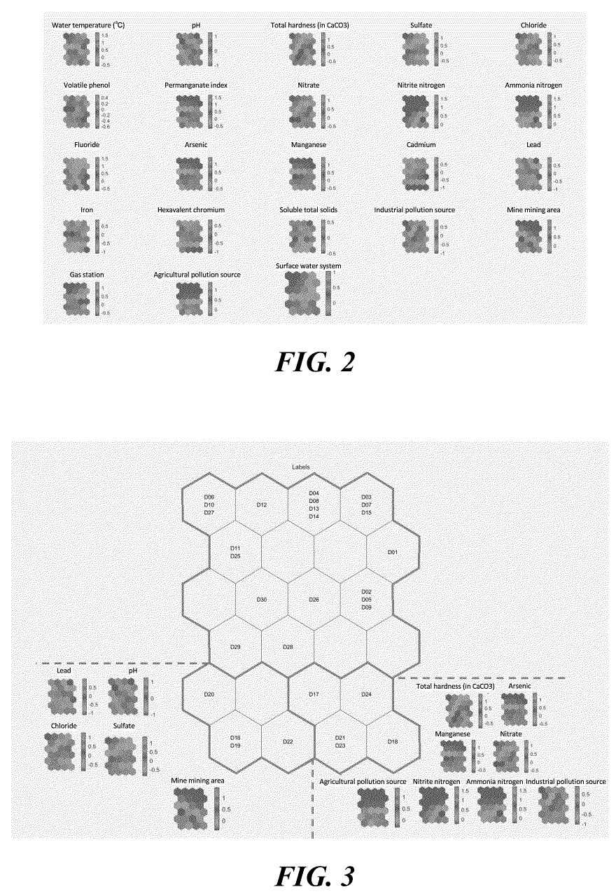

In one application scenario provided in the embodiments of the present disclosure, the calculation results obtained based on the groundwater pollution source identification method provided in this embodiment are shown in FIG. 2 and FIG. 3, and D21, D23, D18, D17, D24 and the like point positions in the lower right represents the high response strength of the nitrate, nitrite, ammonia nitrogen, potassium permanganate concentration, arsenic, and manganese in the feature map; the medium response strength of sulfate and chloride; and fluoride, cadmium, iron and chromium are relatively low, and the groundwater pollution sources of these point positions are mainly based on industrial pollution sources and gas stations, are also influenced by agricultural pollution sources, and are almost not polluted by mining.

D16, D19, D20 and the like point positions in the lower left are positions where the research area is greatly affected by mine exploitation, the higher lead detection is concentrated in the several points, and the response of arsenic and manganese is also relatively high. In addition, the several point positions are also affected by agricultural pollution sources and industrial pollution sources, and the response of nitrate and chloride is also relatively high.

The overall response of point positions D06, D10, D27 and the like at the top is relatively low, the main influence pollution source is industrial pollution source and water-rock interaction, and compared with the point positions clustered to the bottom, the detection of most pollution indexes at the upper point positions are relatively low, and the influence of industrial pollution is small.

According to the method, the potential relationship between the monitoring data and the longitude and latitude coordinates, the surface water system condition, the enterprise type and the like which are difficult to quantify can be explored, the multi-dimensional data dimension reduction clustering result except the pollution index data can be obtained, the high correlation between the pollutant indexes indicates that the pollution index data may have similar source features, and the high correlation between the monitoring index and the pollution source can describe the pollution source to a certain extent.

It should be understood that the sequence number of each step in the above embodiment does not mean the order of execution, and the order of execution of each process shall be determined by its function and internal logic, and shall not constitute any limitation on the implementation process of the embodiment of the disclosure.

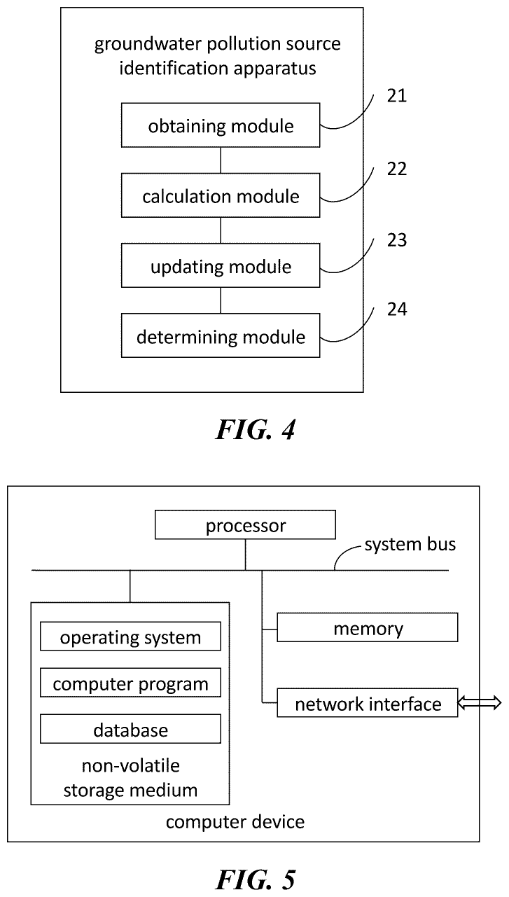

In an embodiment, a groundwater pollution source identification apparatus is provided, and the groundwater pollution source identification apparatus has one-to-one correspondence to groundwater pollution source identification methods in the above embodiments. As shown in FIG. 4, each functional module of the apparatus is described in detail as follows:
obtaining module 21, configured to acquire sample data for groundwater pollution source detection, the sample data at least comprising water chemical index concentration data, pollutant concentration data, longitude and latitude coordinates, surface water system data, and enterprise type data;
calculation module 22, configured to calculate the Euclidean distance and the clustering distance between the sample data and the corresponding output neuron weight vector;
the calculation module 22 is further configured to perform weighted calculation on the Euclidean distance and the clustering distance to determine the winning neuron;
updating module 23, configured to update the output neuron weight vector of the water pollution neural network according to the input neuron weight vector and the output neuron weight vector of the winning neuron;
determining module 24 is configured when the number of updating times of the output neuron weight vector of the water pollution neural network reaches a preset value, determining the groundwater pollution source of the target area by the updated water pollution neural network.

In an optional embodiment of the present disclosure, the calculation module 22 is specifically configured to:
calculating the Euclidean distance between the sample data and the output neuron by the following formula:

$$\\ d ( {x}_{j} ) = \sqrt{{\sum }_{i = 1}^{n} {( {w}_{ji} - {x}_{ji} )}^{2}}$$

where d(xⱼ) is the Euclidean distance between the jth sample data and the output neuron, j∈[1, N], N is the number of the sample data, wⱼᵢ is the output neuron weight vector, xⱼᵢ is the input neuron weight vector corresponding to the ith data dimension in the jth sample data, n is the data dimension of the sample data.

In an optional embodiment of the present disclosure, the calculation module 22 is specifically configured to:
calculating the clustering distance between the sample data and the output neuron by the following formula:

$$\\ dist ( {x}_{j} , {w}_{j} ) = ‖ {x}_{j} - {w}_{j} ‖$$

where dist(xⱼ, wⱼ) is the clustering distance between the sample data and the output neuron, j∈[1, N], N is the number of the sample data, xⱼ is the jth sample data, and wⱼᵢ is the jth output neuron.

In an optional embodiment of the present disclosure, the calculation module 22 is specifically configured to:
the said performing weighted calculation on the Euclidean distance and the clustering distance to determine the winning neuron, including:
   obtaining a minimum Euclidean distance and a minimum clustering distance;
   performing weighted calculation on the minimum Euclidean distance and the minimum clustering distance to determine the winning neuron.

In an optional embodiment of the present disclosure, the updating module 23 is specifically configured to:
obtaining the influence range of the winning neuron;
updating the output neuron weight vector of the water pollution neural network according to the influence range, the input neuron weight vector and the output neuron weight vector of the winning neuron.

In an optional embodiment of the present disclosure, the obtaining module 21 is further configured to calculate an influence range of the winning neuron by using the following formula:

$$\\ σ ( t ) = {σ}_{0} {e}^{{}_{} - \frac{t}{{τ}_{0}}}$$

where σ(t) is the influence range of the winning neuron, σ₀ is the initial influence range of the winning neuron, t is the time length, τ₀ is the fixed attenuation coefficient.

In an optional embodiment of the present disclosure, the updating module 23 is specifically configured to:
updating the output neuron weight vector of the water pollution neural network by using the following formula:

$$\\ Δ {w}_{p} = η ( t ) * T ( t ) * ( {x}_{p} - {w}_{p} )$$

$$\\ η ( t ) = {η}_{0} {e}^{{}_{} - \frac{t}{{τ}_{n}}}$$

$$\\ T ( t ) = {e}^{{}_{} - \frac{{d}_{{pq}_{}}^{{}_{} 2}}{2 {σ ( t )}^{2}}}$$

where Δwₚ is the updated output neuron weight vector of the water pollution neural network, η(t) is the learning coefficient that is attenuated over time, T(t) is the neighborhood influence coefficient, η₀ is the initial value of the learning coefficient, xₚ is the input neuron weight vector of the winning neuron, wₚ is the output neuron weight vector of the winning neuron, d_{pq} is the Euclidean distance between the winning neuron and its neighbor neuron, τ_{η} is the fixed learning coefficient, σ(t) is the influence range of the winning neuron.

For the specific definition of the apparatus, reference may be made to the definition of the groundwater pollution source identification method above, and details are not described herein again. All or some of the modules in the foregoing device may be implemented by software, hardware, and a combination thereof. The foregoing modules may be embedded in or independent of a processor in a computer device in a hardware form, or may be stored in a memory in a computer device in the form of software, so that the processor invokes an operation corresponding to each of the above modules.

In one embodiment, a computer device is provided, the computer device may be a server, and an internal structure diagram thereof may be as shown in FIG. 5. The computer device includes a processor, a memory, a network interface, and a database connected by a system bus. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of an operating system and a computer program in the non-volatile storage medium. The network interface of the computer device is configured to communicate with an external terminal through network connection. When the computer program is executed by the processor, a method for identifying a groundwater pollution source is implemented.

In one embodiment, a computer device is provided, including a memory, a processor, and a computer program stored on the memory and executable on the processor, and when the processor executes the computer program, the following steps are implemented:
acquiring sample data for groundwater pollution source detection, the sample data at least comprising water chemical index concentration data, pollutant concentration data, longitude and latitude coordinates, surface water system data, and enterprise type data;
calculating the Euclidean distance and the clustering distance between the sample data and the corresponding output neuron weight vector;
performing weighted calculation on the Euclidean distance and the clustering distance to determine the winning neuron;
updating the output neuron weight vector of the water pollution neural network according to the input neuron weight vector and the output neuron weight vector of the winning neuron;
when the number of updating times of the output neuron weight vector of the water pollution neural network reaches a preset value, determining the groundwater pollution source of the target area by the updated water pollution neural network.

In one embodiment, a non-transitory computer-readable storage medium is provided, wherein a computer program is stored thereon, and when the computer program is executed by a processor, the following steps are implemented:
acquiring sample data for groundwater pollution source detection, the sample data at least comprising water chemical index concentration data, pollutant concentration data, longitude and latitude coordinates, surface water system data, and enterprise type data;
calculating the Euclidean distance and the clustering distance between the sample data and the corresponding output neuron weight vector;
performing weighted calculation on the Euclidean distance and the clustering distance to determine the winning neuron;
updating the output neuron weight vector of the water pollution neural network according to the input neuron weight vector and the output neuron weight vector of the winning neuron;
when the number of updating times of the output neuron weight vector of the water pollution neural network reaches a preset value, determining the groundwater pollution source of the target area by the updated water pollution neural network.

In one embodiment, a computer program product is provided, the computer program product comprising a computer program, the computer program being executed by a processor to implement the following steps:
acquiring sample data for groundwater pollution source detection, the sample data at least comprising water chemical index concentration data, pollutant concentration data, longitude and latitude coordinates, surface water system data, and enterprise type data;
calculating the Euclidean distance and the clustering distance between the sample data and the corresponding output neuron weight vector;
performing weighted calculation on the Euclidean distance and the clustering distance to determine the winning neuron;
updating the output neuron weight vector of the water pollution neural network according to the input neuron weight vector and the output neuron weight vector of the winning neuron;
when the number of updating times of the output neuron weight vector of the water pollution neural network reaches a preset value, determining the groundwater pollution source of the target area by the updated water pollution neural network.

A person of ordinary skill in the art may understand that all or some of the processes in the method in the foregoing embodiments may be implemented by computer programs instructing related hardware, and the computer program may be stored in a non-volatile computer-readable storage medium, and when executed, the computer program may include a flow of an embodiment of the foregoing methods. Any reference to memory, storage, database, or other medium used in the embodiments provided in this application may include non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include random access memory (RAM) or external cache. By way of illustration, and not limitation, RAM may be available in various forms, such as static RAM (SRAM), dynamic RAM (DRAM), synchronous DRAM (SDRAM), dual data rate SDRAM (DDRSDRAM), enhanced SDRAM (ESDRAM), synchlink DRAM (SLDRAM), memory bus (RAMBUS) direct RAM (RDRAM), direct memory bus dynamic RAM (DRDRAM), memory bus dynamic RAM (RDRAM), and the like.

It can be clearly understood by a person skilled in the art that, for convenience and brevity of description, only the division of the above functional units and modules is illustrated by example, in practical application, the above functions can be assigned by different functional units and modules according to needs, that is, the internal structure of the device is divided into different functional units or modules to complete all or part of the functions described above.

The above embodiments are merely used to illustrate the technical solutions of the present disclosure, rather than limiting the technical solutions of the present disclosure; Although the present disclosure has been described in detail with reference to the foregoing embodiments, it should be understood by those of ordinary skill in the art that they can still modify the technical solutions recited in the foregoing embodiments, or replace some of the technical features therein; however, these modifications or substitutions do not make the nature of the corresponding technical solutions separate from the spirit and scope of the technical solutions of the embodiments of the present disclosure, and should be included within the scope of protection of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for identifying groundwater pollution source, wherein the method comprises:
acquiring sample data for groundwater pollution source detection, the sample data at least comprising water chemical index concentration data, pollutant concentration data, longitude and latitude coordinates, surface water system data, and enterprise type data;
calculating a Euclidean distance and a clustering distance between the sample data and a corresponding output neuron weight vector;
performing weighted calculation on the Euclidean distance and the clustering distance to determine a winning neuron;
updating the output neuron weight vector of the water pollution neural network according to an input neuron weight vector and the output neuron weight vector of the winning neuron; and
when a quantity of updating times of the output neuron weight vector of the water pollution neural network reaches a preset value, determining the groundwater pollution source of the target area by the updated water pollution neural network.

2. The method according to claim 1, wherein calculating the Euclidean distance between the sample data and the corresponding output neuron weight vector includes:
calculating the Euclidean distance between the sample data and the output neuron using the following formula:
$$\\ d ( {x}_{j} ) = \sqrt{{\sum }_{i = 1}^{n} {( {w}_{ji} - {x}_{ji} )}^{2}}$$
where d(xⱼ) is the Euclidean distance between the jth sample data and the output neuron, j∈[1, N], N is the number of the sample data, wⱼᵢ is the output neuron weight vector, xⱼᵢ is the input neuron weight vector corresponding to the ith data dimension in the jth sample data, n is the data dimension of the sample data.

3. The method according to claim 1, wherein calculating the clustering distance between the sample data and the corresponding output neuron weight vector includes:
calculating the clustering distance between the sample data and the output neuron using the following formula:
$$\\ dist ( {x}_{j} , {w}_{j} ) = ‖ {x}_{j} - {w}_{j} ‖$$
where dist(xⱼ, wⱼ) is the clustering distance between the sample data and the output neuron, j∈[1, N], N is the number of the sample data, xⱼ is the jth sample data, and wⱼᵢ is the jth output neuron.

4. The method according to claim 1, wherein performing weighted calculation on the Euclidean distance and the clustering distance to determine the winning neuron includes:
obtaining a minimum Euclidean distance and a minimum clustering distance; and
performing weighted calculation on the minimum Euclidean distance and the minimum clustering distance to determine the winning neuron.

5. The method according to claim 4, wherein updating the output neuron weight vector of the water pollution neural network according to the input neuron weight vector and the output neuron weight vector of the winning neuron includes:
obtaining the influence range of the winning neuron; and
updating the output neuron weight vector of the water pollution neural network according to the influence range, the input neuron weight vector, and the output neuron weight vector of the winning neuron.

6. The method according to claim 4, wherein obtaining the influence range of the winning neuron includes:
calculating the influence range of the winning neuron using the following formula:
$$\\ σ ( t ) = {σ}_{0} {e}^{{}_{} - \frac{t}{{τ}_{0}}}$$
where σ(t) is the influence range of the winning neuron, σ₀ is the initial influence range of the winning neuron, t is the time length, τ₀ is the fixed attenuation coefficient.

7. The method according to claim 5, wherein updating the output neuron weight vector of the water pollution neural network according to the influence range, the input neuron weight vector, and the output neuron weight vector of the winning neuron includes:
updating the output neuron weight vector of the water pollution neural network using the following formula:
$$\\ Δ {w}_{p} = η ( t ) * T ( t ) * ( {x}_{p} - {w}_{p} )$$
$$\\ η ( t ) = {η}_{0} {e}^{{}_{} - \frac{t}{{τ}_{n}}}$$
$$\\ T ( t ) = {e}^{{}_{} - \frac{{d}_{{pq}_{}}^{{}_{} 2}}{2 {σ ( t )}^{2}}}$$
where Δwₚ is the updated output neuron weight vector of the water pollution neural network, η(t) is the learning coefficient that is attenuated over time, T(t) is the neighborhood influence coefficient, η₀ is the initial value of the learning coefficient, xₚ is the input neuron weight vector of the winning neuron, wₚ is the output neuron weight vector of the winning neuron, d_{pq} is the Euclidean distance between the winning neuron and its neighbor neuron, τ_{η} is the fixed learning coefficient, σ(t) is the influence range of the winning neuron.
